(19) United States
(12) Patent Application Publication
(10) Pub. No.: US 2006/0077895 A1
(43) Pub. Date: Apr. 13, 2006

(54) Protocol emulator

(76) Inventor: Cary Wright, Donvale Vic (AU)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/861,618

(22) Filed: Jun. 4, 2004

(51) Int. Cl. H04J 1/16

(52) U.S. Cl. 370/235

(57) ABSTRACT

A protocol emulation system including at least one description that describes fields, using a generic format, in a protocol message. An application transforms the at least one description into a machine-readable template useable by a protocol finite state machine that creates protocol messages based upon the template

### BACKGROUND OF THE INVENTION

Network devices, such as routers, are extensively tested to ensure that erroneous transmissions and fatal errors are minimized. A variety of test devices are available on the marketplace, including the ROUTER TESTER from AGILENT TECHNOLOGIES, assignee of the present application. Such test devices typically monitor the routers response to a variety of simulated input.

The process of routing can be quickly summarized as a node finding the path to every possible destination. Routing is present in everything from layer 1 (the physical layer) on up. The routing that most people are familiar with, however, occurs at layer 3 (the network layer) and as such, only layer 3 (and more specifically) Internet Protocol (IP) routing will be referenced herein. Routers use tables to determine where to forward packets. Updating these tables is a function performed by routing protocols.

Routing protocols facilitate exchanging routing information between routers around the world providing a common view of the network through each router's heterogeneous, though generally consistent, routing tables. Routing tables store all information necessary for the router to reach every destination on the network irrespective of size. There are a wide variety of routing protocols used to distribute information for routing tables across a network, including: BGP; OSPF; RIP; and ISIS. In an attempt to improve router performance, old protocols are often extended and new protocols are continually being created. Typically, new protocols are initially developed by equipment manufacturers and are proprietary in nature. Often, standards bodies in the industry subsequently adopt the protocols.

Known router testers simulate network traffic using specifically created “test packets” of data that are typical of the live data present on the network. These test packets are transmitted to the network device over a network under test. Parameters tested by traffic simulator systems (including ROUTER TESTER) include routing verification, achievement of Quality of Service (QoS) levels under load, and correct inter-working with other devices. Many of these so-called “packet blasters” also test the ability of the network device to adhere to protocols by formulating and transmitting messages in accordance with the protocols. Such messages are known as protocol messages.

FIG. 1 is a block diagram of a traffic simulator test system 100. More particularly, the traffic simulator test system 100 is a general representation of ROUTER TESTER, offered by AGILENT TECHNOLOGIES. ROUTER TESTER is but one example of a router test system and in particular is advertised as a multi-port traffic generation, protocol emulation, and analysis test system for verifying the performance of enterprise, metro/edge, core routing and optical networking devices. The system generally comprises a plurality of protocol emulation cards 102n connected to a system under test, in this case a router 104. Each of the protocol emulation cards 102n generally comprises a processor with associated memory and I/O. A computer 106, such as a PC running a WINDOWS environment, controls the protocol emulation cards 102n. The computer 106 is responsive to an interface 108, such as a graphical user interface.

The test packets and protocol messages produced by the protocol emulation cards 102n are built according to the rules and interpretations of communications protocols, such as those defined by the many standards bodies in the industry. In general, most of the protocol messages associated with any given protocol are used in the process of handshaking between routers. As the handshaking process lends itself to defined states, most routers and protocol emulators use a finite state machine to respond to the various protocol messages.

The current software architecture associated with traffic simulator test systems requires hard-coding all parts of the protocol emulation solution including the graphical user interface, scripting API, configuration and control components, and the protocol state machine itself. The hard coding required for each protocol has resulted in the use of an enormous amount of human talent to create the large body of code.

As the pace of introduction picks up for new protocols or extensions thereto, delivering test suites in a timely manner becomes more and more difficult. Each new variation or addition to a protocol emulation require the modification of source code and a subsequent recompile. Customers of protocol testers have asked for the ability to modify the protocol emulation, often to facilitate testing of an unreleased protocol or extension. To be feasible, such modification should not require a recompilation of the system.

Some available protocol emulators do allow some customization through the use of user defined objects that may be added to a protocol message. However, such customization is in the form of hex codes requiring the user to be familiar with the sometimes arcane codes. Further the objects so defined are static, in that they are incapable of changing during the process of stimulating the network. The objects are limited to being extensions of a main protocol message, meaning that the main body of the message is unchangeable.

Efforts are now being made to design generic systems that can be configured externally to the software. One example is described in co-pending U.S. patent application Ser. No.: 10/266,507, Publication No.: US20040068681 A1, entitled: Building packets of data. US20040068681 A1, incorporated herein by reference, uses an external XML protocol description to drive a generic PDU encode/decode engine.

Accordingly, the present inventors have recognized a need for new apparatus and methods enabling a user to add new capability to a protocol emulation suite without requiring a recompile and to appear to the users as being a seamless part of the system.

### BRIEF DESCRIPTION OF THE DRAWINGS

An understanding of the present invention can be gained from the following detailed description of certain embodiments of the present invention, taken in conjunction with the accompanying drawings of which:

FIG. 1 is a block diagram of a protocol emulation test system.

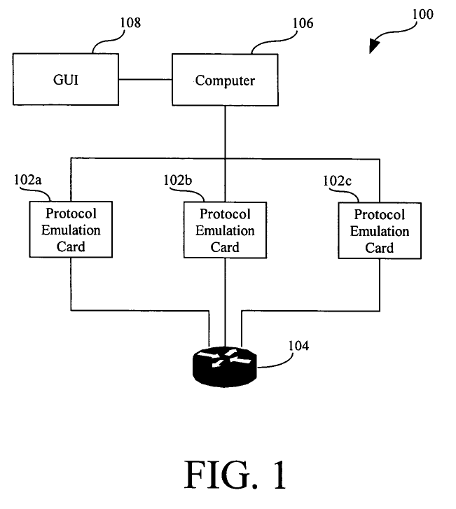

FIG. 2 is a block diagram of an architecture for building protocol messages in accordance with a preferred embodiment of the present invention.

FIG. 3 is a screen shot of a graphical user interface constructed in accordance with an embodiment of the present invention.

In the description contained hereinafter, the use of a lowercase “n” adjacent to an element identifier denotes a non-specific instance of the element rather than a specific element as discussed in the specification using a non-italicized letter adjacent to the element number or the general collection of all instances discussed using the element number by itself with a modifier.

### DETAILED DESCRIPTION

Reference will now be made to embodiments of the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, data generation and acquisition cards, and the like. A routine is here, and generally, conceived to be a sequence of steps or actions leading to a desired result, and as such, encompasses such terms of art as “program,” “objects,” “functions,” “subroutines,” and “procedures.” These descriptions and representations are the means used by those skilled in the art effectively convey the substance of their work to others skilled in the art. For the sake of convenience, the word “network” will hereinafter in the description and claims be used to refer to any one or more of: a communication network, a network device, any other communication device, and any aspect or aspects of a communication system which can be tested using test packets of data.

Embodiments which comprise methods will be described with respect to implementation on a router tester having a configuration similar to the AGILENT ROUTER TESTER, but the methods recited herein may operate on any of a variety of router testers. More to the point, the methods presented herein are not inherently related to any particular device; rather, various devices may be used with routines in accordance with the teachings herein. In particular the methods described herein for transfer of data from one device to another, while being described with respect to router tester function, may be applicable to the data communication field in general. Machines that may perform the functions described herein include those manufactured by such companies as AGILENT TECHNOLOGIES, INC., HEWLETT PACKARD, and TEKTRONIX, INC. as well as other manufacturers of communication equipment.

With respect to the software described herein, those of ordinary skill in the art will recognize that there exist a variety of platforms and languages for creating software for performing the procedures outlined herein. Embodiments of the present invention can be implemented using any of a number of varieties of C, including C⁺⁺. However, those of ordinary skill in the art also recognize that the choice of the exact platform and language is often dictated by the specifics of the actual system constructed, such that what may work for one type of system may not be efficient on another system. It should also be understood that the routines and calculations described herein are not limited to being executed as software on a computer, but can also be implemented in a hardware processor. For example, the routines and calculations could be implemented with HDL (Hardware Design Language) in an ASICS or in an FGPA using a variety of design tools.

Applicants have determined that certain parts of protocol emulation lend themselves to being defined in a generic fashion, while other components may be more suited to being hard coded for scalability and performance reasons. By allowing on-site customization of those portions that may be defined in a generic manner, the customer is given additional control over the protocol emulation and the ability to extend the tests. To facilitate customer interaction, the generically defined portions may be represented in an easily readable file format, for example, XML. Such an XML file can be used to form a graphical interface through which modification to the information described in the XML can be viewed. This information would be used to build a definition understandable by a particular protocol emulation's finite state machine.

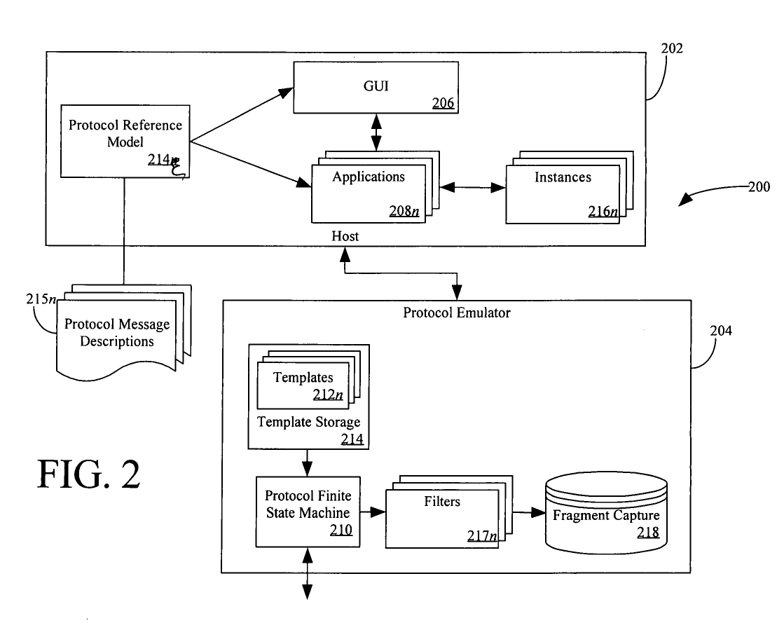

FIG. 2 is a block diagram of a protocol emulation system 200 for building protocol messages in accordance with a preferred embodiment of the present invention. The architecture 200 generally comprises a host 202 and a protocol emulator 204. The host 202 is typically embodied as a computer responsive to a graphical user interface 206 along with applications 208. While a plurality of applications 208n are shown in FIG. 2, it should be noted that, depending on the exact implementation of the present invention, the applications 208n could be physically or logically implemented as a single application, or any number of applications. The protocol emulator 204 generally comprises a protocol finite state machine 210 responsive to at least one template 212 for producing protocol messages. The computer 202 generally acts as a client providing instructions to the protocol emulator 204 that generally acts as a server responding to the instructions of the computer 202.

Protocol message descriptions 215, stored either locally with the host 202 or at a remote location, contain at least one description 215n of all or some of the fields and field relationships for selected protocol message types and the attendant protocol parameter options. A protocol message description 215n represents an entire protocol data unit or a fragment thereof in a generic format (e.g. the format of the filed description 215 does not vary from protocol to protocol). Examples of messages for which protocol message descriptions 215 may prove useful include: BGP4 Update Message; OSPF Link State Update Packet; ISIS Link State Packet; RIP Update Message; LDP Label Mapping Message; LDP Label Request Message; RSVP Path Message; PIM Join or Register Message; and IGMP Membership Reports.

A protocol message description 215n for a given protocol may begin with a protocol descriptor with general attributes pertaining to the protocol, followed by a number of field descriptors, each describing fields that may exist in a message created according to the protocol. The field descriptors may contain a variety of attribute information.

For example, a full name can be specified for display with the values associated with the field. In terms of the value itself, attributes such as length, format, and initial value may be provided. To further enhance the usefulness of the protocol message descriptions 215, instructions regarding how to vary the value of a field from copy to copy of a message (built in accordance with the protocol message descriptions 215) can be provided. In the case of fields that are repeated within a specific message, instruction regarding how to vary the value of the field from instance to instance can be supplied. For example an incremental value can be provided to adjust the IP value prefix in each of a series of network reachability indicators.

If XML is used as the descriptive language, the descriptors may be embodied by tags, which in a known manner, may be nested to provide a hierarchical structure. Such a hierarchical structure facilitates the dynamic creation of a graphical user interface that offers quick and easy navigation through the data structure.

The protocol message descriptions 215 may be formed in accordance with the general teaching of U.S. patent application Ser. No. 10/266,507 (published at US 2004/0068681 A1) incorporated herein by reference. Table 1 contains an example of a protocol definition for a BGP4 Update message. The data structure shown in Table 1 provides an example of a protocol message description 215n as embodied in XML and from which structure and purpose can be extracted by those of ordinary skill in the art to enable the creation of other protocol definitions for other messages and other protocols.

```
TABLE 1
<?xml version=“1.0” standalone=“yes”?>
<ProtocolSet xmlns=“x-schema:AgtPduSchema.xml” version=“1”
providedBy=“Agilent Technologies”>
<!-- -˜-˜-˜-˜-˜-˜-˜-˜-˜-˜-˜-˜-˜-˜-˜-˜-˜-˜-˜-˜-˜-˜-˜-˜- -->
<! -- Generic PDU Builder -->
<!-- -˜-˜-˜-˜-˜-˜-˜-˜-˜-˜-˜-˜-˜-˜-˜-˜-˜-˜-˜-˜-˜-˜-˜-˜- -->
<!-- File type: protocol definition -->
<!-- Content : BGP4 Update Message -->
<!-- Copyright 2004 Agilent Technologies -->
<!-- -˜-˜-˜-˜-˜-˜-˜-˜-˜-˜-˜-˜-˜-˜-˜-˜-˜-˜-˜-˜-˜-˜-˜-˜- -->
<!-- Version History : -->
<!-- 0.1 : May 2004 - Prototype -->
<!-- -˜-˜-˜-˜-˜-˜-˜-˜-˜-˜-˜-˜-˜-˜-˜-˜-˜-˜-˜-˜-˜-˜-˜-˜- -->
<! -- =========================================== --
>
<protocol name=“BGP4 Update”
  shortName=“BGP4 Update Message”
  fullName=“Border Gateway Protocol Version 4 Update Message”
  instance=“primary”
  standard=“RFC 1771”
  sequence=“header path_attributes network_layer_reachability”>
  <field name=“header”
    fullName=“Header”
    instance=“primary”
    sequence=“marker length update_type no_withdrawn_routes”>
  <field name=“marker”
    fullName=“Marker”
    length=“128”
    value=“0xFFFFFFFFFFFFFFFFFFFFFFFFFFFFFFFF”
    format=“hex”/>
  <field name=“length”
    fullName=“Length”
    length=“16”
    format=“integer”/>
  <field name=“update_type”
    fullName=“Message type”
    length=“8”
    format=“integer”
    value=“2”/>
  <field name=“no_withdrawn_routes”
    fullName=“Unfeasible routes length”
    length=“16”
    value=“0”
    format=“integer”/>
  <field name=“ipv4_address_prefix”
    fullName=“IP address prefix”
    instance=“repeat”
    pad=“octet”
    sequence=“prefix_length prefix”/>
  <field name=“prefix_length”
    fullName=“Prefix length (bits)”
    length=“8”
    format=“integer”/>
  <field name=“prefix”
    fullName=“Prefix”
    lengthRef=“prefix_length”
    lengthMultiplier=“1”
    defaultLength=“24”
    format=“hex”/>
  <field name=“path_attributes”
    fullName=“PATH attributes”
    select=“no_path_attributes has_path_attributes”
default=“no_path_attributes”/>
  <field name=“no_path_attributes”
    fullName=“Total PATH attribute length”
    length=“16”
    value=“0”
    format=“integer”/>
  <field name=“has_path_attributes”
    fullName=“PATH attributes”
    sequence=“total_path_attribute_length path_attribute_data”/>
  <field name=“total_path_attribute_length”
    fullName=“Total PATH attribute length”
    length=“16”
    format=“integer”/>
  <field name=“path_attribute_data”
    fullName=“PATH attributes”
    lengthRef=“total_path_attribute_length”
    lengthMultiplier=“8”
    sequence=“path_attribute”/>
  <field name=“path_attribute”
    fullName=“PATH attribute”
    instance=“repeat”
    sequence=“attr_flags attr_type attr_length attr_value”/>
  <field name=“attr_flags”
    fullName=“Attribute flags”
    format=“binary”
    length=“8”
    flags=“Optional Transitive Partial Extended_Length Null Null Null
Null”/>
  <field name=“attr_type”
    fullName=“Attribute type code”
    format=“integer”
    length=“8”>
    <enum value=“1” name=“ORIGIN”/>
    <enum value=“2” name=“AS PATH”/>
    <enum value=“3” name=“NEXT HOP”/>
    <enum value=“4” name=“MULTI EXIT DISC”/>
    <enum value=“5” name=“LOCAL PREF”/>
    <enum value=“6” name=“ATOMIC AGGREGATE”/>
    <enum value=“7” name=“AGGREGATOR”/>
    <enum value=“14” name=“MP_REACH_NLRI”/>
    <enum value=“15” name=“MP_UNREACH_NLRI”/>
  </field>
  <field name=“attr_length”
    fullName=“Attribute length”
    select=“normal_length extended_length”
    default=“normal_length”/>
  <field name=“normal_length”
    fullName=“Attribute length (1 byte)”
    length=“8”
    format=“integer”/>
  <field name=“extended_length”
    fullName=“Attribute length (2 bytes)”
    length=“16”
    format=“integer”/>
  <field name=“attr_value”
    fullName=“Attribute data”
    lengthRef=“attr_length”
    lengthMultiplier=“8”
    select=“origin as_path next_hop multi_exit_disc local_pref
atomic_aggregate aggregator”
    default=“as_path”/>
  <field name=“origin”
    fullName=“ORIGIN value”
    selectRef=“attr_type”
    selectValue=“1”
    length=“8”
    format=“integer”>
    <enum value=“0” name=“IGP”/>
    <enum value=“1” name=“EGP”/>
    <enum value=“2” name=“INCOMPLETE”/>
  </field>
  <field name=“as_path”
    fullName=“AS PATH”
    selectRef=“attr_type”
    selectValue=“2”
    sequence=“path_segment”/>
  <field name=“path_segment”
    fullName=“Path segment”
    instance=“repeat”
    sequence=“ps_type ps_length ps_value”/>
  <field name=“ps_type”
    fullName=“Path segment type”
    length=“8”
    format=“integer”>
    <enum value=“1” name=“AS_SET”/>
    <enum value=“2” name=“AS_SEQUENCE”/>
  </field>
  <field name=“ps_length”
    fullName=“Path segment AS count”
    length=“8”
    format=“integer”/>
  <field name=“ps_value”
    fullName=“Path segment AS list”
    lengthRef=“ps_length”
    lengthMultiplier=“16”
    sequence=“ps_as”/>
  <field name=“ps_as”
    fullName=“Path segment AS”
    length=“16”
    instance=“repeat”
    format=“integer”/>
  <field name=“next_hop”
    fullName=“NEXT HOP”
    selectRef=“attr_type”
    selectValue=“3”
    length=“32”
    format=“ipv4_address”/>
  <field name=“multi_exit_disc”
    fullName=“MULTI EXIT DISC”
    selectRef=“attr_type”
    selectValue=“4”
    length=“32”
    format=“integer”/>
  <field name=“local_pref”
    fullName=“LOCAL PREF”
    selectRef=“attr_type”
    selectValue=“5”
    length=“32”
    format=“integer”/>
  <field name=“atomic_aggregate”
    fullName=“ATOMIC AGGREGATE”
    selectRef=“attr_type”
    selectValue=“6”
    length=“0”
    format=“integer”/>
  <field name=“aggregator”
    fullName=“AGGREGATOR”
    selectRef=“attr_type”
    selectValue=“7”
    sequence=“aggregator_as aggregator_address”/>
  <field name=“aggregator_as”
    fullName=“Aggregator AS”
    length=“16”
    format=“integer”/>
  <field name=“aggregator_address”
    fullName=“Aggregator address”
    length=“32”
    format=“ipv4_address”/>
  <field name=“network_layer_reachability”
    fullName=“Network layer reachability”
    select=“ipv4_address_prefix ipv6_mp_nlri”
default=“ipv4_address_prefix”/>
  <field name=“ipv6_mp_nlri”
    fullName=“IPv6 Multi Protocol Network Layer Reachability
    Information”
    instance=“primary”
    sequence=“mpr_attr_type mp_attr_len ipv6_afi unicast_safi
next_hop_len next_hop num_snpas nlri_per_update ipv6_nlri”/>
  <field name=“mpr_attr_type”
    fullName=“Attribute Type”
    length=“8”
    value=“14”
    format=“integer”/>
  <field name=“mp_attr_len”
    fullName=“Attribute Length”
    length=“8”
    value=“0”
    format=“integer”/>
  <field name=“ipv6_afi”
    fullName=“Address Family Indicator”
    shortName=“AFI”
    length=“8”
    value=“2”
    format=“integer”/>
  <field name=“unicast_safi”
    shortName=“SAFI”
    length=“8”
    value=“1”
    format=“integer”/>
  <field name=“next_hop_len”
    fullName=“Next Hop Length”
    length=“8”
    value=“128”
    format=“integer”/>
  <field name=“next_hop”
    fullName=“Next Hop Address”
    length=“128”
    value=“0”
    format=“ipv6_address”/>
  <field name=“num_snpas”
    fullName=“Number of SNPA's”
    length=“8”
    value=“0”
    format=“integer”/>
  <field name=“nlri_per_update”
    fullName=“Max Number of NLRI's for each Update Message”
    length=“16”
    value=“500”
    instance=“FSM_variable”
    format=“integer”/>
  <field name=“ipv6_nlri”
    fullName=“IPv6 Network layer Reachability Information”
    instance=“FSM_repeat”
    sequence=“ipv6_prefix_len ipv6_prefix”/>
  <field name=“ipv6_prefix_len”
    fullName=“IPv6 Prefix Length”
    length=“8”
    value=“96”
    format=“integer”/>
  <field name=“ipv6_prefix”
    fullName=“IPv6 Prefix Length”
    length=“128”
    value=“0”
    format=“ipv6_address”/>
</protocol>
<!-- ========================================== --
>
</ProtocolSet>
```

To create new protocol emulations, an application 208n retrieves the requested protocol message description(s) 215n and loads them into a protocol reference model 214. The reference model 214 generally comprises a data structure, such as an object, that describes the fields contained in all selected protocol message description 215n. The model can be constructed by parsing each protocol message description 215n using, for example, a public domain XML parser software such as expat. Once the protocol reference model 214 is constructed, an instance 216n thereof can be instantiated and populated with user designated values and instructions.

To edit the values stored by an instance 216n, the instance 216n is passed to the GUI 206. Alternatively, the GUI 206 can request the instantiation of an instance 216n. In any event, the GUI 206 forms a graphical display based on selected fields in the protocol reference model 214, a protocol message description 215n or an instance 216n. In perhaps the preferred embodiment, the GUI 206 constructs and populates a tree mimicking the nested data structure represented by the protocol message descriptions 215.

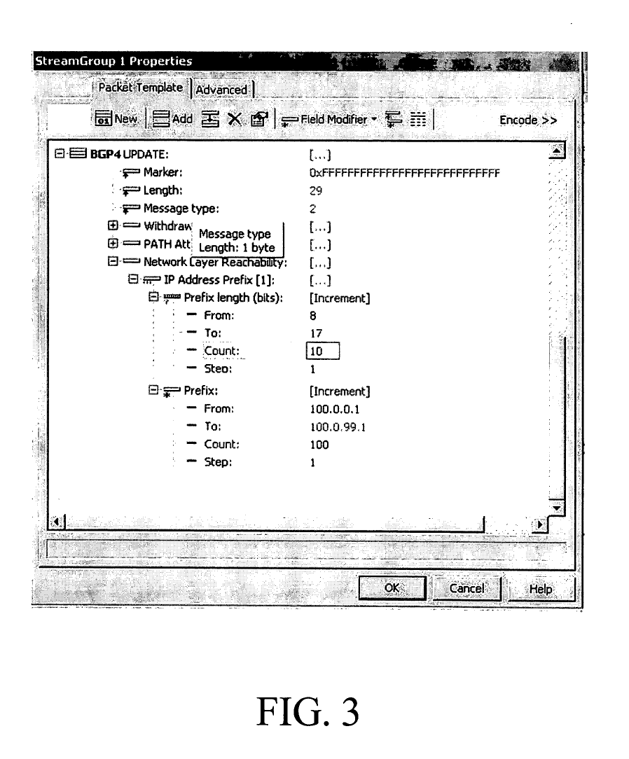

FIG. 3 is a screen shot of a graphical user interface 206 constructed in accordance with an embodiment of the present invention. To generate a display, such as that shown in FIG. 3, the content of, for example, the protocol reference model 214 is analyzed to identify the fields for display and the format thereof. In the example shown in FIG. 3, a hierarchical data structure is created and populated with an entry or display field, wherein each field is a node in the tree. The resulting tree structure may then represented in a conventional hierarchical display wherein data nodes are formatted based upon their descriptors.

In the example shown in FIG. 3, the user is permitted to adjust certain attributes of the displayed fields, including starting value, ending value, the count and the step allowing control on a field by field basis based on the content of the protocol message description 215n (or more properly the instance 216n). For example, an attribute can be added to note that the value of the field is fixed (or dependent upon another field). Once the user has reviewed the nodes and adjusted the nodes available to him or her, the graphical user interface 206 passes the adjusted instance 216n back to an application 208n. An application 208n then constructs a template 212n based on the adjusted instance 216n.

A template 212 is a set of instructions to the protocol finite state machine 210 regarding the creation of protocol messages. It may be beneficial to use a binary (or hex) format for the templates 212 so as to correspond to the currently hard coded instruction used by protocol finite state machine 210. In this manner, current protocol finite state machines should require little in the way of modification to interact with templates 212. Referring to FIG. 2, either the graphical user interface 206 or an applications 208n may be constructed to act as a complier of protocol message descriptions 215. Templates 212 generally have three segments as shown in table 2:

TABLE 2
PDU Template X

Common Part PDU
Construction Data
Repeating Part PDU
Construction Data

Templates 212 generally comprise a first part (termed the common part) of non-repeating data, and a second part (termed the repeating part) of repeating portions with similarly formatted data of differing values. Each template 212n represents a base message description, from which many messages can be generated. Each template 212n has a common part, and may have a repeating part. The common part may have fields that vary across a sequence of generated messages. The common part typically represents the message header and common attributes for the topology data. In BGP the common part of an Update message may include the message header and path attributes. The repeating part describes a set of fields that are to be repeated several times within a single message. One or more of the repeating fields may vary, in a defined manner, with each repetition. The repeating part generally represents network topology data. In BGP, the repeating part may include the many thousands of network prefixes to be advertised.

Referring back to FIG. 2, each instance 216 is stored as a vector of protocol elements. A template 212 may be formed by encoding byte-strings of the vector. The byte-string may be encoded by concatenating the binary value of each enabled field within the vector of protocol elements. It may prove beneficial to store both the vector representation and the encoded representation. In such a case, when the GUI 206 updates an instance 216 by manipulating an element within the vector (i.e. value changed, field enabled or disabled), the corresponding byte string is updated. A field modifier may be applied to any element within the vector; the field modifier may be encoded relative to the byte string as an offset, field width, start value, increment and count. A template 212 generally comprises set of field modifiers accompanying the encoded byte strings.

An optional feature that may be implemented is the use of a flag (or other data structure) to indicate whether a template is to be used during any session. Thus, if the flag for any given template 212n is set, that template 212n is used by the protocol finite state machine 210 to generate messages. The flag can be part of the template or kept elsewhere, for example as part of a register or table.

During operation, the protocol finite state machine 210 would perform an initial handshake operation. At the appropriate point, the protocol finite state machine 210 would access available templates (limited to those with an ON flag if such option is desired) and start constructing messages based on the templates.

The protocol message descriptions 215 are also suitable for use as filters. Users of protocol emulation systems, such as the system 200, generally want to review traffic transmitted to the system. However, the volume of such traffic tends to be quite heavy, such that sorting through the traffic for messages, or portions of messages, of interest can be cumbersome. One benefit to the use of the protocol message descriptions 215 is that they form an excellent basis for filter definitions that can be applied to the incoming message streams to identify messages, or portions of messages of, interest.

In accordance with an embodiment of the present invention, the protocol message descriptions 215 are utilized to form filters 217. To construct a filter a variety of methods may be utilized. In perhaps the preferred embodiment, selected protocol message descriptions 215n are loaded into the protocol reference model 214 and presented to the user, via the GUI 206, for modification. The user provides values for each of the available fields upon which a message is to be filtered. Such values can be designated as either filtering the message in (e.g. the message is to be saved) or filtering the message out (e.g. the message is to be discarded). The filters 217 can be structured to identify portions (or “fragments”) of messages to save in the event the message is filtered in. As in the case of templates 212, the GUI 206 and or an application 208n creates a filter 217n based on the supplied data (along with the protocol message description 215) and transmit the filter 217n to the protocol emulator 204 for storage. Any available filtering algorithm may be used such that the actual structure of filters 216 may vary depending on the implementation of the protocol emulator and the selected filtering algorithm.

During operation, the filters 216 are applied to incoming data to the protocol finite state machine 210. Messages, or fragments thereof, which are filtered in are stored in a fragment capture database 218. The fragment capture database 218 can be either remote or local to the protocol emulator 204.

The fragment capture database 218 stores captured data in a machine readable format as a series of captured records. The database 218 may contain only a single fragment type, or a variety of fragment types, with associated fragment type descriptors. To present the fragments in a human readable form, an application 208n uses the protocol reference model 214 to decode a fragment's binary data into a set of field descriptions, values and formatting rules. The GUI 206 presents the contents of the fragments to the user in a graphical form. Alternatively, an application programming interface (“api”) can be constructed to allow access to the database 218 from any application.

Although certain embodiments of the present invention have been shown and described, it will be appreciated by those skilled in the art that changes may be made in these embodiments without departing from the principles and spirit of the invention, the scope of which is defined in the claims and their equivalents.

For example, the use of protocol message descriptions 215 facilitate the extension of defined protocol emulations. Table 3 represents the field definition defined in Table 2 with extensions for Multicast IPv6.

```
TABLE 3
<?xml version=“1.0” standalone=“yes”?>
<ProtocolSet xmlns=“x-schema:AgtPduSchema.xml” version=“1”
providedBy=“Agilent Technologies”>
<!-- -˜-˜-˜-˜-˜-˜-˜-˜-˜-˜-˜-˜-˜-˜-˜-˜-˜-˜-˜-˜-˜-˜-˜-˜- -->
<!-- Generic PDU Builder -->
<!-- -˜-˜-˜-˜-˜-˜-˜-˜-˜-˜-˜-˜-˜-˜-˜-˜-˜-˜-˜-˜-˜-˜-˜-˜- -->
<!-- File type: protocol definition -->
<!-- Content : BGP4 Update Message -->
<!-- Copyright 2004 Agilent Technologies -->
<!-- -˜-˜-˜-˜-˜-˜-˜-˜-˜-˜-˜-˜-˜-˜-˜-˜-˜-˜-˜-˜-˜-˜-˜-˜- -->
<!-- Version History : -->
<!-- 0.1 : May 2004 - Prototype -->
<!-- -˜-˜-˜-˜-˜-˜-˜-˜-˜-˜-˜-˜-˜-˜-˜-˜-˜-˜-˜-˜-˜-˜-˜-˜- -->
<!-- =========================================== --
>
<protocol name=“BGP4 Update”
  shortName=“BGP4 Update Message”
  fullName=“Border Gateway Protocol Version 4 Update Message”
  instance=“primary”
  standard=“RFC 1771”
  sequence=“header path_attributes network_layer_reachability”>
  <field name=“header”
    fullName=“Header”
    instance=“primary”
    sequence=“marker length update_type no_withdrawn_routes”>
  <field name=“marker”
    fullName=“Marker”
    length=“128”
    value=“0xFFFFFFFFFFFFFFFFFFFFFFFFFFFFFFFF”
    format=“hex”/>
  <field name=“length”
    fullName=“Length”
    length=“16”
    format=“integer”/>
  <field name=“update_type”
    fullName=“Message type”
    length=“8”
    format=“integer”
    value=“2”/>
  <field name=“no_withdrawn_routes”
    fullName=“Unfeasible routes length”
    length=“16”
    value=“0”
    format=“integer”/>
  <field name=“ipv4_address_prefix”
    fullName=“IP address prefix”
    instance=“repeat”
    pad=“octet”
    sequence=“prefix_length prefix”/>
  <field name=“prefix_length”
    fullName=“Prefix length (bits)”
    length=“8”
    format=“integer”/>
  <field name=“prefix”
    fullName=“Prefix”
    lengthRef=“prefix_length”
    lengthMultiplier=“1”
    defaultLength=“24”
    format=“hex”/>
  <field name=“path_attributes”
    fullName=“PATH attributes”
    select=“no_path_attributes has_path_attributes”
default=“no_path_attributes”/>
  <field name=“no_path_attributes”
    fullName=“Total PATH attribute length”
    length=“16”
    value=“0”
    format=”integer”/>
  <field name=“has_path_attributes”
    fullName=“PATH attributes”
    sequence=“total_path_attribute_length path_attribute_data”/>
  <field name=“total_path_attribute_length”
    fullName=“Total PATH attribute length”
    length=“16”
    format=“integer”/>
  <field name=“path_attribute_data”
    fullName=“PATH attributes”
    lengthRef=“total_path_attribute_length”
    lengthMultiplier=“8”
    sequence=“path_attribute”/>
  <field name=“path_attribute”
    fullName=“PATH attribute”
    instance=“repeat”
    sequence=“attr_flags attr_type attr_length attr_value”/>
  <field name=“attr_flags”
    fullName=“Attribute flags”
    format=“binary”
    length=“8”
    flags=“Optional Transitive Partial Extended_Length Null Null Null
Null”/>
  <field name=“attr_type”
    fullName=“Attribute type code”
    format=“integer”
    length=“8”>
    <enum value=“1” name=“ORIGIN”/>
    <enum value=“2” name=“AS PATH”/>
    <enum value=“3” name=“NEXT HOP”/>
    <enum value=“4” name=“MULTI EXIT DISC”/>
    <enum value=“5” name=“LOCAL PREF”/>
    <enum value=“6” name=“ATOMIC AGGREGATE”/>
    <enum value=“7” name=“AGGREGATOR”/>
    <enum value=“14” name=“MP_REACH_NLRI”/>
    <enum value=“15” name=“MP_UNREACH_NLRI”/>
  </field>
  <field name=“attr_length”
    fullName=“Attribute length”
    select=“normal_length extended_length”
    default=“normal_length”/>
  <field name=“normal_length”
    fullName=“Attribute length (1 byte)”
    length=“8”
    format=“integer”/>
  <field name=“extended_length”
    fullName=“Attribute length (2 bytes)”
    length=“16”
    format=“integer”/>
  <field name=“attr_value”
    fullName=“Attribute data”
    lengthRef=“attr_length”
    lengthMultiplier=“8”
    select=“origin as_path next_hop multi_exit_disc local_pref
atomic_aggregate aggregator”
    default=“as_path”/>
  <field name=“origin”
    fullName=“ORIGIN value”
    selectRef=“attr_type”
    selectValue=“1”
    length=“8”
    format=“integer”>
    <enum value=“0” name=“IGP”/>
    <enum value=“1” name=“EGP”/>
    <enum value=“2” name=“INCOMPLETE”/>
  </field>
  <field name=“as_path”
    fullName=“AS PATH”
    selectRef=“attr_type”
    selectValue=“2”
    sequence=“path_segment”/>
  <field name=“path_segment”
    fullName=“Path segment”
    instance=“repeat”
    sequence=“ps_type ps_length ps_value”/>
  <field name=“ps_type”
    fullName=“Path segment type”
    length=“8”
    format=“integer”>
    <enum value=“1” name=“AS_SET”/>
    <enum value=“2” name=“AS_SEQUENCE”/>
  </field>
  <field name=“ps_length”
    fullName=“Path segment AS count”
    length=“8”
    format=“integer”/>
  <field name=“ps_value”
    fullName=“Path segment AS list”
    lengthRef=“ps_length”
    lengthMultiplier=“16”
    sequence=“ps_as”/>
  <field name=“ps_as”
    fullName=“Path segment AS”
    length=“16”
    instance=“repeat”
    format=“integer”/>
  <field name=“next_hop”
    fullName=“NEXT HOP”
    selectRef=“attr_type”
    selectValue=“3”
    length=“32”
    format=“ipv4_address”/>
  <field name=“multi_exit_disc”
    fullName=“MULTI EXIT DISC”
    selectRef=“attr_type”
    selectValue=“4”
    length=“32”
    format=“integer”/>
  <field name=“local_pref”
    fullName=“LOCAL PREF”
    selectRef=“attr_type”
    selectValue=“5”
    length=“32”
    format=“integer”/>
  <field name=“atomic_aggregate”
    fullName=“ATOMIC AGGREGATE”
    selectRef=“attr_type”
    selectValue=“6”
    length=“0”
    format=“integer”/>
  <field name=“aggregator”
    fullName=“AGGREGATOR”
    selectRef=“attr_type”
    selectValue=“7”
    sequence=“aggregator_as aggregator_address”/>
  <field name=“aggregator_as”
    fullName=“Aggregator AS”
    length=“16”
    format=“integer”/>
  <field name=“aggregator_address”
    fullName=“Aggregator address”
    length=“32”
    format=“ipv4_address”/>
  <field name=“network_layer_reachability”
    fullName=“Network layer reachability”
    select=“ipv4_address_prefix ipv6_mp_nlri”
default=“ipv4 address prefix”/>
  <field name=“ipv6_mp_nlri”
    fullName=“IPv6 Multi Protocol Network Layer Reachability
    Information”
    instance=“primary”
    sequence=“mpr_attr_type mp_attr_len ipv6_afi unicast_safi
next_hop_len next_hop num_snpas nlri_per_update ipv6_nlri”/>
  <field name=“mpr_attr_type”
    fullName=“Attribute Type”
    length=“8”
    value=“14”
    format=“integer”/>
  <field name=“mp_attr_len”
    fullName=“Attribute Length”
    length=“8”
    value=“0”
    format=“integer”/>
  <field name=“ipv6_afi”
    fullName=“Address Family Indicator”
    shortName=“AFI”
    length=“8”
    value=“2”
    format=“integer”/>
  <field name=“unicast_safi”
    shortName=“SAFI”
    length=“8”
    value=“1”
    format=“integer”/>
  <field name=“next_hop_len”
    fullName=“Next Hop Length”
    length=“8”
    value=“128”
    format=“integer”/>
  21 field name=“next_hop”
    fullName=“Next Hop Address”
    ength=“128”
    value=“0”
    format=“ipv6_address”/>
  <field name=“num_snpas”
    fullName=“Number of SNPA's”
    length=“8”
    value=“0”
    format=“integer”/>
  <field name=“nlri_per_update”
    fullName=“Max Number of NLRI's for each Update Message”
    length=“16”
    value=“500”
    instance=“FSM_variable”
    format=“integer”/>
  <field name=“ipv6_nlri”
    fullName=“IPv6 Network layer Reachability Information”
    instance=“FSM_repeat”
    sequence=“ipv6_prefix_len ipv6_prefix”/>
  <field name=“ipv6_prefix_len”
    fullName=“IPv6 Prefix Length”
    length=“8”
    value=“96”
    format=“integer”/>
  <field name=“ipv6_prefix”
    fullName=“IPv6 Prefix Length”
    length=“128”
    value=“0”
    format=“ipv6_address”/>
  <field name=“ipv6_mulitcast_mp_nlri”
    fullName=“IPv6 Multicast Multi Protocol Network Layer
Reachability Information”
    instance=“primary”
    sequence=“mpr_attr_type mp_attr_len ipv6_afi multicast_safi
next_hop_len next_hop num_snpas nlri_per_update ipv6_nlri”/>
</protocol>
<!-- =========================================== --
>
</ProtocolSet>
```

As the GUI 206 maybe programmed to dynamically create a graphical display based on a protocol message description 215, no additional programming is necessary for the creation of a user interface to a newly defined protocol message description 215n. Further, assuming that any replication operation defined in the new protocol message description 215n has been defined in the software that converts protocol message descriptions 215 to templates 212, no new coding need be undertaken within the protocol finite state machine 210.

What is claimed is:

1. A protocol emulation system comprising:
at least one description that describes fields, using a generic format, in a protocol message;
an application that transforms the at least one description into a machine-readable template; and
a protocol finite state machine that creates protocol messages based upon the template.

2. A protocol emulation system, as set forth in claim 1, wherein the generic format comprises XML.

3. A protocol emulation system, as set forth in claim 1, wherein the protocol messages are used in a handshake process with a router.

4. A protocol emulation system, as set forth in claim 1, wherein the at lease one description comprises a plurality of descriptions.

5. A protocol emulation system, as set forth in claim 1, wherein the application transforms the at least one description into a reference model.

6. A protocol emulation system, as set forth in claim 5, further comprising:
a graphical user interface that presents the user with a graphical representation of the description and receives modifications to values contained in the description, and wherein the application instantiates the reference model and populates the instance with values received from the graphical user interface.

7. A protocol emulation system, as set forth in claim 6, wherein the application transforms the instance into the machine-readable template.

8. A protocol emulation system, as set forth in claim 1, wherein the template is hex encoded.

9. A protocol emulation system, as set forth in claim 1, further comprising an application that transforms the description into a filter and where in the filter is used to filter a plurality of messages received by the protocol emulation system.

10. A method for controlling a protocol emulator, the method comprising:
creating a description of the structure of data for controlling the protocol emulator, the description being formed using a language generic to a plurality of protocols;
creating a reference model of the data structure using the description;
creating an instance of the reference model with at least some user provided data;
using the instance to create a template to which the protocol emulator is responsive for creating protocol messages; and
transferring the template to the protocol emulator.

11. A method, as set forth in claim 10, wherein the step of creating a description comprises creating an XML file that describes the structure of data.

12. A method, as set forth in claim 10, wherein the description includes instructions on how to vary at least one value across multiple copies of protocol messages.

13. A method, as set forth in claim 10, wherein the description includes values that are based on other values within the description.

14. A method, as set forth in claim 10, wherein the step of preparing a description comprises describing the data in a hierarchical manner.

15. A method, as set forth in claim 10, wherein the step of preparing a description of the structure of the data comprises defining fields for holding values, other fields, or attributes of the fields.

16. A method, as set forth in claim 15, wherein the attributes include a full name of the field, a length of the field, a presentation format of the field, sequencing instructions, and a range of possible values for the element.

17. A method, as set forth in claim 10, further comprising:
creating a filter based on the description; and
using the filter to filter a plurality of messages received by the protocol emulation system.

18. A method of controlling a protocol emulator, the method comprising:
creating an XML description of at least one message used by the protocol emulator;
presenting a user with a graphical display of the description;
permitting the user to adjust values in a plurality of fields of the description; and
creating a template for controlling a protocol finite state machine based on the description and the values as adjusted by the user.

19. A method, as set forth in claim 18, further comprising;
permitting the user to specify how at least one field is to vary from message to message in a sequence of messages; and
including in the template instructions on how to vary the at least one field from message to message.

20. A method, as set forth in claim 18, further comprising:
permitting the user to set filter values in a plurality of fields of the description;
creating a filter based on the description and the filter values set by the user; and
using the filter to filter a plurality of messages received by the protocol emulation system.
